(19) United States
(12) Patent Application Publication
(10) Pub. No.: US 2009/0157742 A1
(43) Pub. Date: Jun. 18, 2009

(54) On Demand Capture of Database Application Environmental Resources

(76) Inventors: Mark John Anderson, Oronoco, MN (US); James Michael Flanagan, Rochester, MN (US); Scott Forstie, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/954,373

(22) Filed: Dec. 12, 2007

(51) Int. Cl. G06F 17/30

(52) U.S. Cl. 707/104.1; 707/E17.005

(57) ABSTRACT

A method and apparatus for tracking a plurality of database resource consumers is provided. A request is received from a job for a database resource of a plurality of resources. Based on the request, a database resource allocation amount for the job is updated. The database resource allocation amount specifies an amount of the database resource allocated to the job. It is determined whether the job is a primary consumer for the resource. A primary consumer is defined according to a consumption of the database resource relative to other database resource consumers. The determining is based on the database resource amount allocated to the job; and a respective database resource amount allocated to each of the plurality of database resource consumers. Upon determining that the job is one of the plurality of primary consumers, the job is added to a stored list identifying the primary consumers for the database resource.

### BACKGROUND OF THE INVENTION

1. Field of the Invention

The field of the invention relates to database management systems (DBMSs), specifically to tracking database application resource consumption.

2. Description of the Related Art

Programmers of database applications are keenly aware of the need to avoid application failures, whether through an application crashing or consuming inordinate amounts of database resources. Programmers, or software engineers, have various levels of database expertise when developing applications. The typical lack of database expertise leads to sub-optimal application designs, and resultant application failures in production environments.

A database includes more than just data. A database management system (DBMS) is a set of programs and resources that regulate access, and modifications to data within a database. Typically, a DBMS manages a set of resources to facilitate efficient exchanges between a database application, and a database.

In most cases, application programmers are not even aware that database application environmental resources exist, that there are best practices for using resources, and that there are hard limits on consuming some resources to avoid application failures. Typically, an application programmer only becomes aware of these environmental resources when an application either performs poorly or stops running. Traditional approaches of managing database resources have focused on database administrators' tracking the size and performance characteristics of database objects, such as table space sizes and the number of columns or rows in a table.

There are numerous ways that the inefficient use of database resources is typically solved, such as hardware level monitoring and tracing to identify inefficient configurations and application designs. The combination of tracing and post-trace analysis is one of the most popular approaches.

### SUMMARY OF THE INVENTION

The present invention generally provides a method and apparatus for tracking a plurality of database resource consumers. A request is received from a database job for a database resource of a plurality of database resources. Based on the request, a database resource allocation amount of the database resource for the database job is updated. The database resource allocation amount specifies an amount of the database resource allocated to the database job. It is determined whether the database job is a primary consumer for the database resource. A primary consumer is defined according to a consumption of the database resource relative to other database resource consumers. The determining is based on the database resource allocation amount of the database resource, allocated to the database job; and a respective database resource allocation amount of the database resource, allocated to each of the plurality of database resource consumers. Upon determining that the database job is one of the plurality of primary consumers for the database resource, the database job is added to a list identifying one or more primary database resource consumers for the database resource. The list is stored on a computer-readable storage medium.

According to one embodiment, a computer-readable storage medium contains a program which, when executed, performs an operation. A request is received from a database job for a database resource of a plurality of database resources. Based on the request, a database resource allocation amount of the database resource for the database job is updated. The database resource allocation amount specifies an amount of the database resource allocated to the database job. It is determined whether the database job is a primary consumer for the database resource. A primary consumer is defined according to a consumption of the database resource relative to other database resource consumers. The determining is based on the database resource allocation amount of the database resource, allocated to the database job; and a respective database resource allocation amount of the database resource, allocated to each of the plurality of database resource consumers. Upon determining that the database job is one of the plurality of primary consumers for the database resource, the database job is added to a list identifying one or more primary database resource consumers for the database resource. The list is stored on a computer-readable storage medium.

According to one embodiment, a system comprises a memory containing code, and a processor which, when executing the code receives, from a database job, a request for a database resource of a plurality of database resources. Based on the request, the processor updates a database resource allocation amount of the database resource for the database job. The database resource allocation amount specifies an amount of the database resource allocated to the database job. It is determined whether the database job is a primary consumer for the database resource. A primary consumer is defined according to a consumption of the database resource relative to other database resource consumers. The determining is based on the database resource allocation amount of the database resource, allocated to the database job, and a respective database resource allocation amount of the database resource, allocated to each of the plurality of database resource consumers. Upon determining that the database job is one of the plurality of primary consumers for the database resource, the database job is added to a list identifying one or more primary database resource consumers for the database resource. The list is stored on a computer-readable storage medium.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram illustrating a system for tracking database application resource consumption, according to one embodiment of the invention.

FIG. 2 is a block diagram illustrating an example allocation of resources to jobs 212, according to one embodiment of the invention.

FIG. 3 illustrates an example job-resource allocation table, according to one embodiment of the invention.

FIG. 4 is a message flow diagram for database resource allocation, according to one embodiment of the invention.

FIG. 5 is an example screen shot of a GUI presented to a user by the tracker client, according to one embodiment of the invention.

FIG. 6 illustrates an example screen shot of a GUI with a context menu through which a user may interact with available jobs, according to one embodiment of the invention.

### DETAILED DESCRIPTION OF THE PREFERRED EMBODIMENTS

The present invention generally provides a method and apparatus for tracking the heaviest consumers of particular database resources for a database management system. As database jobs request database resources, allocation amounts for the granted requests are updated in a data store for each database job. Upon user request, the top n consumers of any of the tracked resources are displayed in a graphical user interface.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

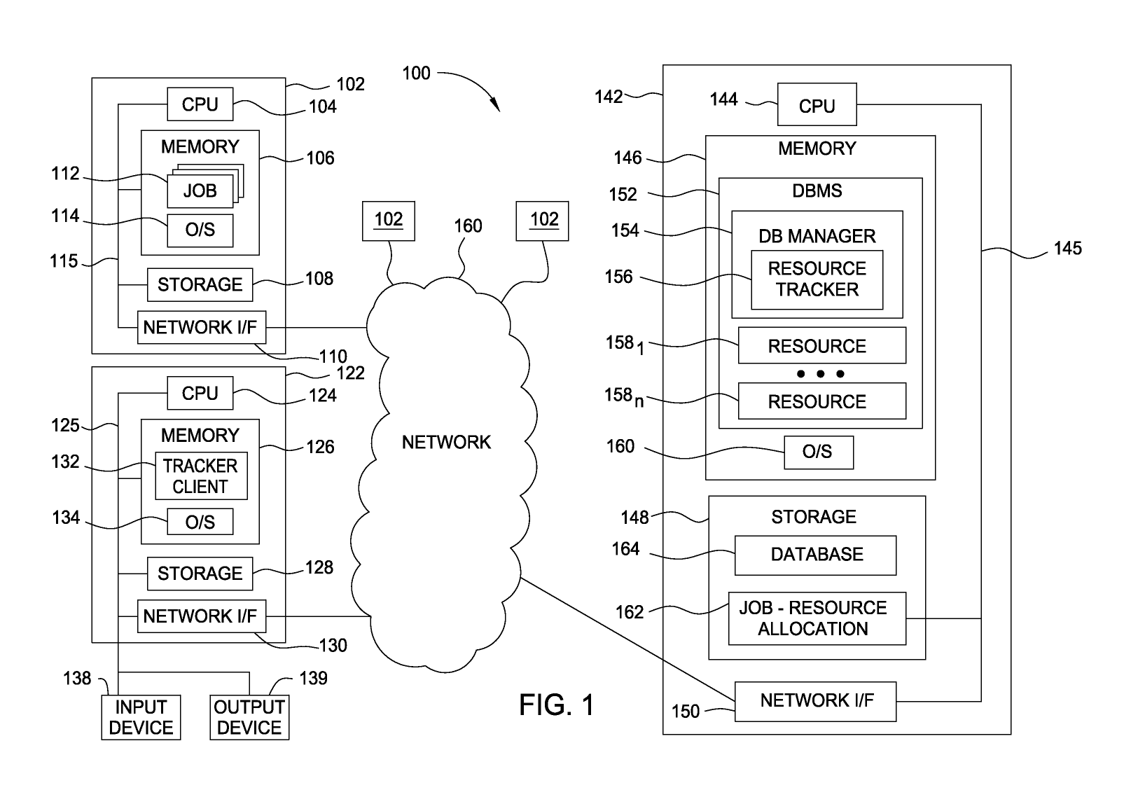

FIG. 1 is a block diagram illustrating a system 100 for tracking database application resource consumption, according to one embodiment of the invention. In general, the networked system 100 includes at least one application server 102 (three such servers are shown), a client (e.g., user's) computer 122, and a database server 142. The application server 102, client computer 122, and database server 142 are connected via a network 160. In general, the network 160 may be a local area network (LAN) and/or a wide area network (WAN). In a particular embodiment, the network 160 is the Internet.

The application server 102 includes a Central Processing Unit (CPU) 104 connected via a bus 115 to a memory 106, storage 108, and a network interface (I/F) device 110. The processor 104 could be any processor used to perform an embodiment of the invention.

The memory 106 may be a random access memory sufficiently large to hold the necessary programming and data structures that are located on the application server 102. The programming and data structures may be accessed and executed by the CPU 104 as needed during operation. While the memory 106 is shown as a single entity, it should be understood that the memory 106 may in fact comprise a plurality of modules, and that the memory 106 may exist at multiple levels, from high speed registers and caches to lower speed but larger DRAM chips. The memory 106 also includes at least one job (a plurality of jobs 112 are shown) that retrieves and/or updates data stored on the database server 142.

The network interface device 110 may be any entry/exit device configured to allow network communications between the application server 102, the client 122, and the database server 142 via the network 160. For example, the network interface device 110 may be a network adapter or other network interface card (NIC).

Storage 108 may be a Direct Access Storage Device (DASD). Although it is shown as a single unit, it could be a combination of fixed and/or removable storage devices, such as fixed disc drives, floppy disc drives, tape drives, removable memory cards, or optical storage. The memory 106 and storage 108 could be part of one virtual address space spanning multiple primary and secondary storage devices.

The application server 102 is generally under the control of an operating system 114, which is shown in the memory 106. Examples of operating systems 114 include UNIX, versions of the Microsoft Windows® operating system, and distributions of the Linux® operating system. (Note: Linux is at trademark of Linus Torvalds in the United States and other countries.) More generally, any operating 114 system supporting the functions disclosed herein may be used.

Database server 142 generally comprises a Central Processing Unit (CPU) 144, a memory 146, a storage 148, and a network interface device 150, coupled to one another by a bus 145. The client computer 122 may be similarly constructed with a Central Processing Unit (CPU) 124 connected via a bus 125 to a memory 126, storage 128, and a network interface (I/F) device 130.

The processors 124,144 could be any processor used to perform an embodiment of the invention. The memories 126, 146 may each be a random access memory sufficiently large to hold the necessary programming and data structures that are located on the client computer 122 and database server 142, respectively. The programming and data structures may be accessed and executed by the CPUs 124, 144 as needed during operation. While the memories 126, 146 are shown as single entities, it should be understood that the memories 126, 146 may in fact each comprise a plurality of modules, and that the memories 126, 146 may exist at multiple levels, from high speed registers and caches to lower speed but larger DRAM chips. Storage 128, 148 may each be a Direct Access Storage Device (DASD). Although it is shown as a single unit, each storage could be a combination of fixed and/or removable storage devices, such as fixed disc drives, floppy disc drives, tape drives, removable memory cards or optical storage. The memories 126, 146 and storage 128, 148 could be part of one virtual address space spanning multiple primary and secondary storage devices. The network interface devices 130, 150 may be any entry/exit device configured to allow network communications between the database server 142, the client 122, and the application server 102 via the network 160. For example, the network interface device 130, 150 may be a network adapter or other network interface card (NIC).

The input device 138 can be any device to give input to the application server 102. For example, a keyboard, keypad, light pen, touch-screen, track-ball, or speech recognition unit, audio/video player, and the like could be used.

The output device 139 can be any device to give output to the user or an audience for an advertisement, e.g., any conventional display screen or set of speakers, along with their respective interface cards, i.e., video cards and sound cards (not shown). Although shown separately from the input device 138, the output device 139 and input device 138 could be combined. For example, a display screen with an integrated touch-screen, a display with an integrated keyboard, or a speech recognition unit combined with a text speech converter could be used.

As shown, the memory 146 includes a database management system (DBMS) 152 and an operating system 160. The DBMS 152 is configured to service requests from the jobs 112 to read and update a database 164.

A DBMS 152 includes a database manager 154 and numerous database resources 158. The database manager 154 manages the resources 158 to facilitate access to the database 164 for the jobs 112.

Examples of resources 158 include SQL Call Level Interface (CLI) handles, SQL active descriptors, activation groups, and pseudo closed cursors. The SQL CLI handles generally provide database 164 access/update functionality in such a way as to eliminate the need to pre-compile database applications, i.e., jobs 112, and as such, free jobs 112 from specific database management systems. SQL active descriptors provide a way for jobs 112 to query and update buffered data stores as the buffered data relates to specific columns and rows in a database 164. Activation groups allow multiple jobs 112 to share database objects without impacting each other's performance.

Further, database resources 158 are also impacted by particular job activities, which in one embodiment, are also tracked. Examples of job activities include prepared statements, active prepared statements, longest SQL statement prepared, number of times using a temporary access plan, and largest number of tables referenced in a statement.

Prepared statements are query language statements that jobs 112 create dynamically using internal variables. Information about active prepared statements, and the longest statement prepared are also important in determining a job's use of database resources. Temporary access plans specify an order of operations for accessing data in the database, and the more times a job 112 uses a temporary access plan, the more resources 158 the job 112 consumes.

A cursor is another example of a resource 158. The jobs 112 require cursors to read and update data in the database 164. To read data, an SQL open cursor is required. To make permanent changes to a database 164, a cursor must be closed. The database manager 154 creates, opens, and closes cursors for the jobs 112. Database applications, e.g., the jobs 112, use cursors to point to a specific row within an ordered set of rows. An SQL open cursor withholds data updates performed by a database application until the database application expressly commits the updates to the database. Because closing cursors requires an affirmative action by the database application, a single application typically has numerous cursors open at any one time during execution. Pseudo closed cursors are a performance enhancing resource that delay the actual closing of cursors.

Each of the foregoing exemplary resources place demands on the DBMS 152. For example, SQL open cursors put demands on the memory allocated to the DBMS 152. In fact, the amount of memory allocated by the DBMS 152 correlates directly to the number of cursors currently open. Because available memory influences the performance of the database, and the job 112, using an inordinate amount of SQL open cursors can diminish database performance. Accordingly, diminished database performance hurts the performance of all the jobs that are executing at the same time as the job that uses an excessive amount of one or more resources.

Accordingly, the database manager 154 manages the resources allocated to the various jobs 112. To this end, the database manager 154 includes the resource tracker 156, according to one embodiment. The resource tracker 156 monitors requests for resources 158, and maintains a job-resource allocation component 162. The job-resource allocation component 162 may be a data structure that identifies the amount of each resource 158 allocated to each of the jobs 112.

As shown, the storage 148 includes at least one database 164. The database 164 is the physical representation of an organized set of data. The physical representation includes the data itself, and the data structures (e.g., tables, relationships) that contain the data. The DBMS 152 processes requests from the jobs 112 to read and update data, and data structures within the database 164.

The client computer 122 is generally under the control of an operating system 134, which is shown in the memory 126. Generally, any operating system supporting the functions disclosed herein may be used.

The memory 126 also includes a tracker client 132. According to one embodiment, the tracker client 132 is a program that displays the top n consumers, e.g., jobs 112, of each of the database resources 158 to a user, where n may be an implementation-specific quantity. For example, one implementation of the tracker client may display the top ten consumers of each resource 158. Other implementations may display more or fewer consumers of each resource. In one embodiment, the tracker client 132 presents a graphical user interface (GUI) listing the top n consumers of each of the database resources 158. The database server 142 and/or application server 102 may be configured with input and output devices (not shown) for invoking the tracker client 132.

FIG. 1 is merely one hardware/software configuration for the networked application server 102, client computer 122, and database server 142. Embodiments of the present invention can apply to any comparable hardware configuration, regardless of whether the computer systems are complicated, multi-user computing apparatus, single-user workstations or network appliances that do not have non-volatile storage of their own. Further, it is understood that while reference is made to particular languages, including SQL, the invention is not limited to a particular language, standard or version. Accordingly, persons skilled in the art will recognize that the invention is adaptable to other languages and that the invention is also adaptable to future changes in a particular language as well as to other languages presently unknown. The various components of the embodiments of the invention need not be distributed as shown in FIG. 1. Rather, all the components may reside on the same machine.

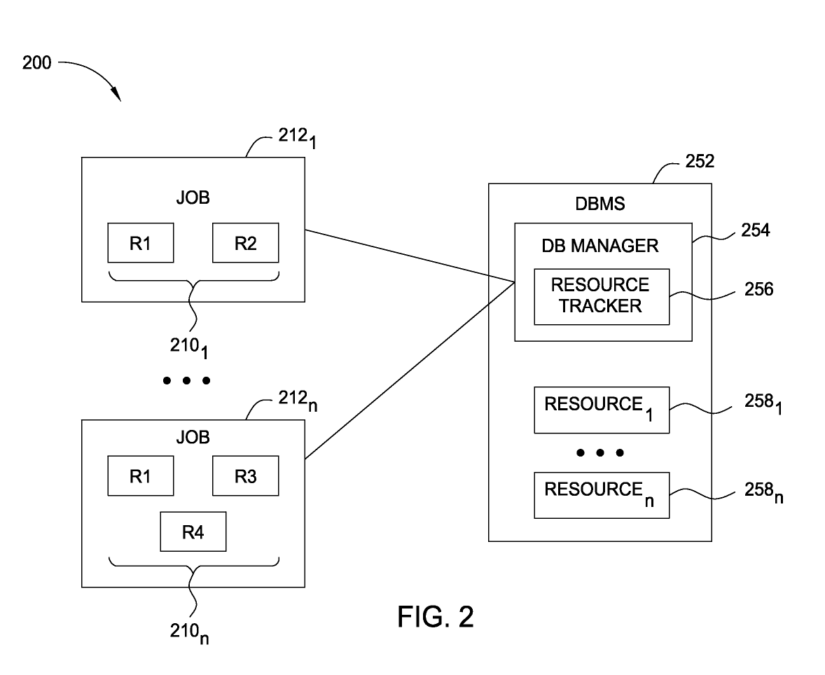

FIG. 2 is a block diagram illustrating an example allocation 200 of resources 258 to jobs 212, according to one embodiment of the invention. Allocation 200 includes jobs 212₁₋ₙ, and DBMS 252. The DBMS 252 contains database resources 258₁₋ₙ. A particular resource, e.g., resource 258₁, may be assigned to one or more jobs 212.

Each of the jobs 212₁₋ₙ has a particular resource assignment 210₁₋ₙ. For example, resource assignment 210₁ for job 212₁ includes resources “R1,” and “R2.” “R1” and “R2” may represent database resources 258₁ and 258₂, respectively. Each job 212 that accesses DBMS 252 may have numerous resources 258 assigned. As one job 212 consumes greater amounts of a resource 258, the performance of all the jobs 212 accessing the DBMS 252 may be impacted.

For example, the availability of a resource 258 such as large object (LOB) locators may be limited to sixteen million LOB locators. In other words, the assignment of LOB locators to the job 212 reduces the number of LOB locators available to other jobs 212. As the number of available LOB locators is significantly reduced, jobs 212 requiring LOB locators may stall, or even abort. Accordingly, the job 212 that consumes an amount approaching the limit of a particular resource 258, may detrimentally impact the performance of all jobs 212 accessing the DBMS 252, including the DBMS 252 itself.

In embodiments of the invention, some resources 258 may not have limits defined. However, in such a case, heavy consumption of the resource 258, may still detrimentally impact the performance of all jobs 212 accessing the DBMS 252. For example, there is no limit on the number of SQL active descriptors, nor pseudo closed cursors used by a job 212. However, heavy consumption of SQL active descriptors and pseudo closed cursors impacts the performance of all jobs 212 accessing the DBMS 252.

Even in the case where the job's resource consumption does not approach the resource's limit, determining the top n consumers of a resource may assist application developers in improving the efficiency of database applications. For example, identifying one job 212 as one of the top n consumers of SQL open cursors may alert a user to an inefficiency whereby the user may update the job 212 to reduce the number of SQL open cursors in the job 212. In one embodiment, updating the job includes modifying SQL statements being executed by the job.

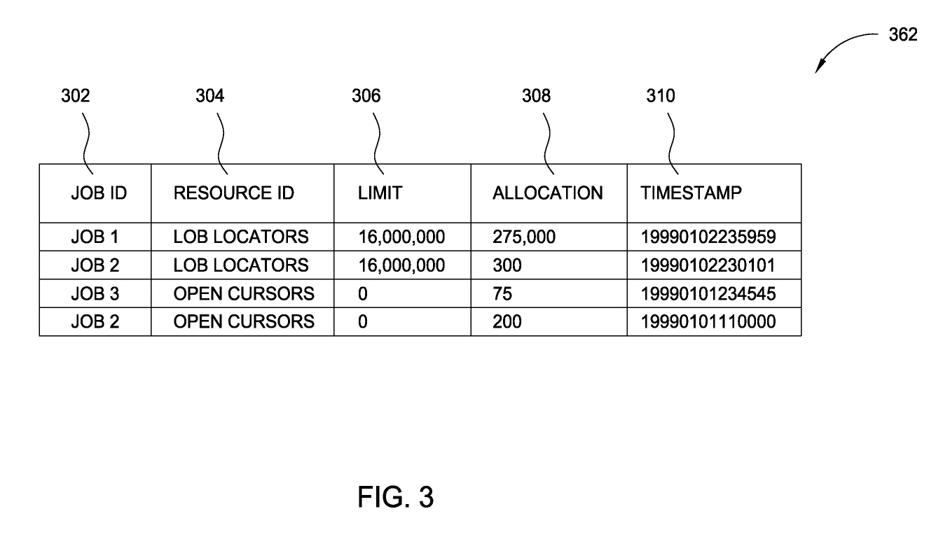

FIG. 3 illustrates an example of a job-resource allocation table 362, according to one embodiment of the invention. Table 362 includes a job id field 302, resource id field 304, resource limit field 306, resource allocation field 308, and a timestamp field 310.

Entries in the job id field 302 identify the consumer of a particular database resource 258. Entries in the resource id field 304 identify the database resource 258 being allocated for the respective job id in the job id field 302. Entries in the limit field 306 specify the maximum allocation allowed for the respective resource id (if any) in the resource id field 304. In some embodiments of the invention, the limit values in the limit field 306 may be specified by job, database, or database management system. The entries in the allocation field 308 identify the recorded allocation amount for the resource id (in field 304) and the job id (in field 302).

Table 300 may identify database resource allocation for active jobs, and may also contain historical allocation data for inactive jobs. Accordingly, the timestamp 310 specifies the date and time that the allocation 308 is recorded. In some embodiments, the tracker client 132 may identify the top n consumers of a particular resource 258 for active jobs, inactive jobs, and both active and inactive jobs.

As is shown in the first row, a job 212 with job id, “JOB 1,” has a resource allocation recorded for large object (LOB) locators. In this example, the limit 306 for LOB locators for the DBMS is sixteen million. For resources 258 without hard limits, the limit 306 may be expressed as zero (shown in row 2 of table 300). The allocation for JOB 1 is 275,000, recorded at 11:59:59 P.M. on Jan. 2, 1999. The other rows in table 300 include similar values.

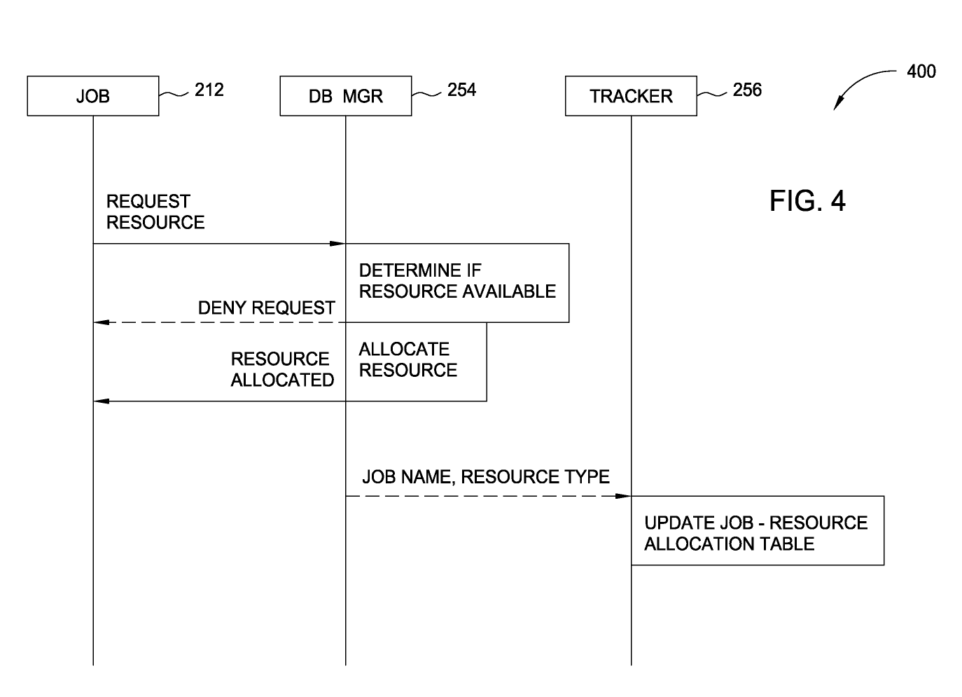

FIG. 4 is a message flow diagram 400 for database resource allocation, according to one embodiment of the invention. When a job 212 requires a database resource 258, the job 212 may send a message to the database manager 254 requesting the resource 258. The message may include a resource id and a job identifier.

In response to receiving a resource request, the database manager 254 may determine whether the resource requested is available. If not, the database manager 254 may send a message to the job 212, denying the request. If the resource is available, the database manager 254 may allocate the resource for the job, and send a message to the job affirming the successful allocation of the resource 258. Further, the database manager may send a message to the tracker 256, identifying the job, and the resource allocated.

In response, the tracker 256 may update the job-resource allocation table 300 with the current allocation amount for the job and resource identified in the message from the database manager 254.

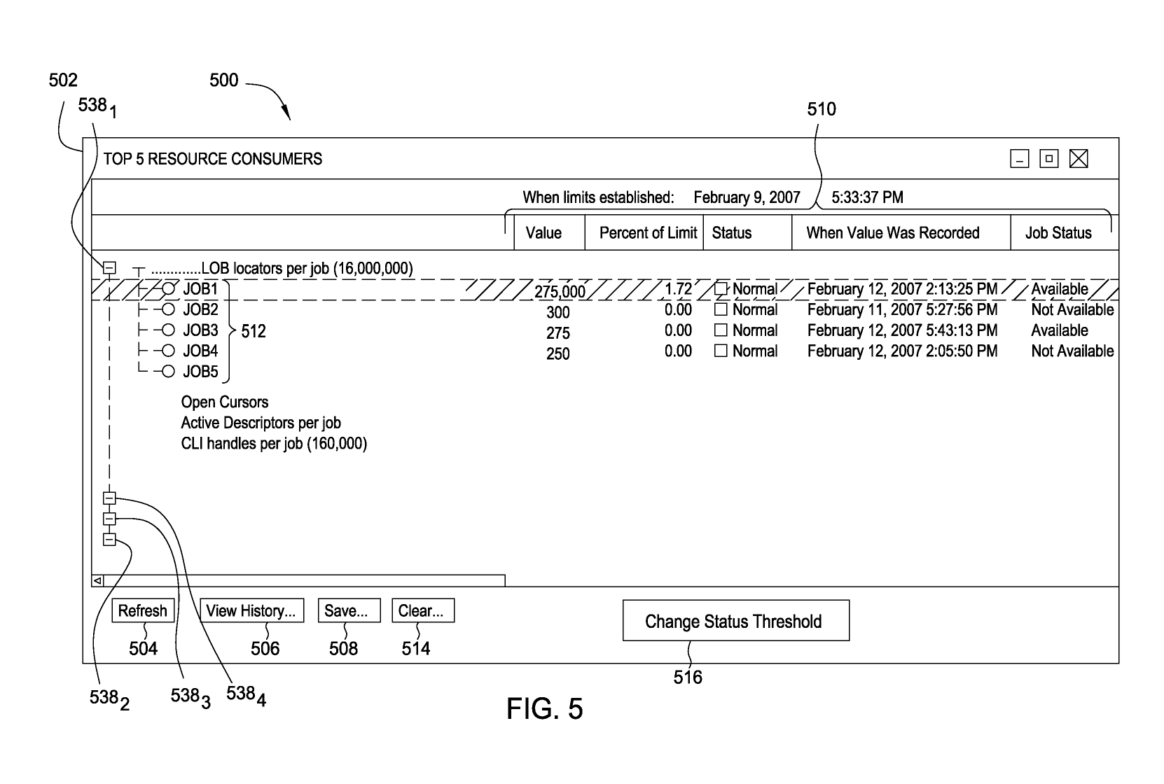

FIG. 5 is an example screen shot of a GUI 500 presented to a user by the tracker client 132, according to one embodiment of the invention. As shown, the GUI 500 includes the title 502, resource consumption detail 510, resource headers 538, job IDs 512, refresh button 504, view history button 506, save button 508, clear button 514, and change status threshold button 516. According to one embodiment, a user may see on the GUI 500-on demand-how much of a database environmental resource 258 has been used by the top 5 consumers of the resource 258. In this example, the top 5 consumers include both active and inactive jobs.

The resource headers 538 describe database resources 258, recorded as resource 304 in job-resource allocation table 300. In this example screen shot, the tracked database resources 258 include, “LOB Locators,” “SQL open cursors,” “SQL active descriptors,” and “CLI Handles.” The resource headers 538 also include a limit for the resource 258, where applicable. As shown, the limit for LOB locators is 16,000,000. A LOB locator is a token value, generated by the DBMS 252, which provides for efficient random access of a large object stored in a database. A large object could be a picture, or video file stored in a database record.

Job IDs 512 identifies the jobs that are the top 5 consumers of the resource identified by the resource header 538. As shown, JOBs 1-5 are the top 5 consumers of LOB Locators.

Resource consumption detail 510 may vary according to the implementation of a particular embodiment. In this example, detail 510 include, “Value, Percent of Limit, Status, When Value Was Recorded, and Job Status.” Value may be a raw value of the number of resources 258 allocated to the job 212, recorded as allocation 308 in job-resource allocation table 300. Percent of Limit may be a formula of the Value with regard to the limit. As shown, JOB 1 has 275,000 LOB locators allocated, which is 1.72 percent of the 16 million LOB locator limit.

Status may describe the job's resource use. Possible values may include, “Normal” and “High.” In one embodiment, a High status may indicate resource consumption above a user-defined threshold. As shown, a change status threshold button 516 may be provided for defining the threshold amount in terms of Value, or Percent of Limit.

“When Value Was Recorded” may be the timestamp 310 stored in the job-resource allocation table 300. Finally, “Job Status” may specify whether a job is currently executing, i.e., “Available.” As shown, JOB 1 is Available.

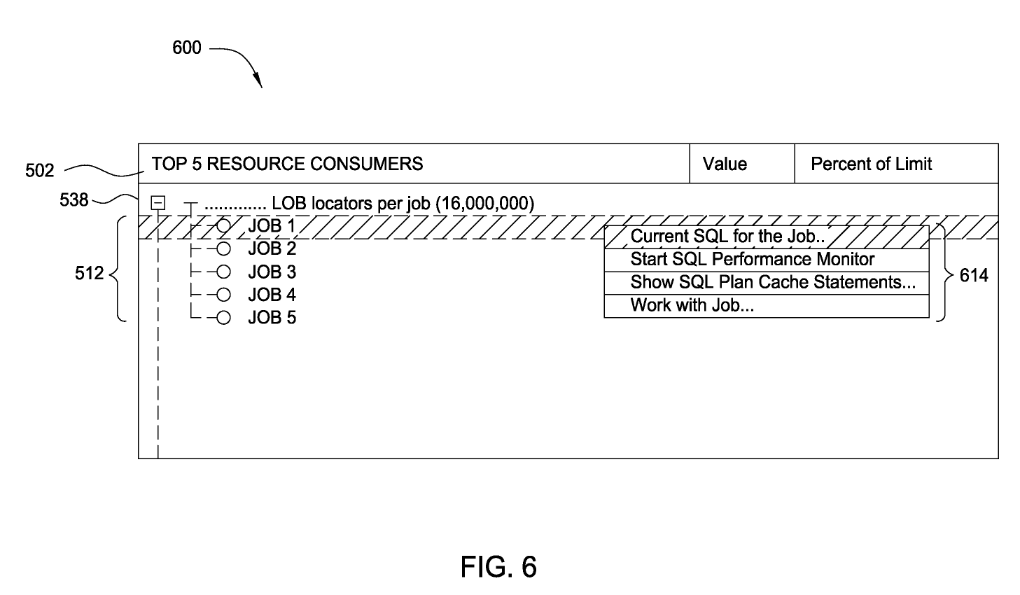

In some embodiments, a user may interact with available jobs to isolate performance issues, or to perform debugging. FIG. 6 illustrates a screen of a GUI 600 with a context menu through which a user may interact with available jobs, according to one embodiment of the invention.

GUI 600 includes the title 502, job ids 512, and resource headers 538 described in FIG. 5. GUI 600 also includes context menu 614. In some embodiments, a user may invoke the display of the context menu 614 by right-clicking a cursor on the job id 512 of an Available job. As shown in FIG. 5, JOB 1 is available. Accordingly, the context menu 614 is provided for JOB 1.

The context menu 614 may include a list of tools available to the user for interacting with the job 212. The tools may be a collection of tools known in the art, or tools to be developed. Shown is a list of example interactive tracing and debugging tools: “Current SQL for the Job, Start SQL Performance Monitor, Show SQL Plan Cache Statements, and Work with Job.” Using interactive tools with the on-demand capture of resource consumption, a user may identify, in real time, design inefficiencies in the use of environmental resource consumption in executing code.

While the foregoing is directed to embodiments of the present invention, other and further embodiments of the invention may be devised without departing from the basic scope thereof, and the scope thereof is determined by the claims that follow.

What is claimed is:

1. A computer-implemented method of tracking a plurality of database resource consumers, the method comprising:
receiving, from a database job, a request for a database resource of a plurality of database resources;
based on the request, updating a database resource allocation amount of the database resource for the database job, wherein the database resource allocation amount specifies an amount of the database resource allocated to the database job; and
determining whether the database job is a primary consumer for the database resource, wherein a primary consumer is defined according to a consumption of the database resource relative to other database resource consumers, the determining based on:
the database resource allocation amount of the database resource, allocated to the database job; and
a respective database resource allocation amount of the database resource, allocated to each of the plurality of database resource consumers;
upon determining that the database job is one of the plurality of primary consumers for the database resource:
adding the database job to a list identifying one or more primary database resource consumers for the database resource; the list being stored on a computer readable storage medium.

2. The method of claim 1, further comprising:
receiving a user request to view the one or more primary database resource consumers for the database resources; and
presenting the list to the user.

3. The method of claim 1, further comprising:
receiving a user-specified minimum database resource allocation amount, wherein:
the user-specified minimum database resource allocation amount specifies a minimum quantity of the database resource that the database job must be allocated to be the primary database resource consumer for the database resource; and
determining whether the database job is the primary database resource consumer for the database resource is further based on the user-specified minimum database resource allocation amount.

4. The method of claim 1, wherein the list further comprises:
a database resource allocation limit for the database resource;
the database resource allocation amount;
a timestamp specifying the time when the database job was allocated the database resource allocation amount; and
the database resource.

5. The method of claim 4, wherein the database resource is at least one of:
SQL open cursors;
large object locators;
call level interface handles; and
SQL active descriptors.

6. The method of claim 1, further comprising:
receiving a plurality of requests for the plurality of database resources from a plurality of database jobs;
based on the plurality of requests, updating a plurality of database resource allocation amounts of the plurality of database resources for the respective database jobs, wherein the plurality of database resource allocation amounts specify a respective amounts of the plurality of database resources allocated to the respective database jobs; and
determining a plurality of primary consumers for each of the plurality of database resources, wherein the plurality of primary consumers is the plurality of database resource consumers allocated an amount of each of the plurality of database resources in excess of a certain amount relative to other database resource consumers, the determining based on the plurality of database resource allocation amounts of the plurality of database resources, allocated to the plurality of database jobs.

7. The method of claim 6, further comprising:
receiving a request to view the plurality of primary database resource consumers for the plurality of database resources; and
outputting the list for display.

8. The method of claim 6, further comprising:
receiving a plurality of user-specified minimum database resource allocation amounts; and
determining the plurality of primary database resource consumers for each of the plurality of database resources is further based on the plurality of user-specified minimum database resource allocation amounts.

9. A computer-readable storage medium containing a program which, when executed, performs an operation, comprising:
receiving, from a database job, a request for a database resource of a plurality of database resources;
based on the request, updating a database resource allocation amount of the database resource for the database job, wherein the database resource allocation amount specifies an amount of the database resource allocated to the database job; and
determining whether the database job is a primary consumer for the database resource, wherein a primary consumer is defined according to a consumption of the database resource relative to other database resource consumers, the determining based on:
the database resource allocation amount of the database resource, allocated to the database job; and
a respective database resource allocation amount of the database resource, allocated to each of the plurality of database resource consumers;
upon determining that the database job is one of the plurality of primary consumers for the database resource:
adding the database job to a list identifying one or more primary database resource consumers for the database resource; the list being stored on a computer readable storage medium.

10. The computer-readable storage medium of claim 9, further comprising:
receiving a user request to view the one or more primary database resource consumers for the database resources; and
presenting the list to the user.

11. The computer-readable storage medium of claim 9, further comprising:
receiving a user-specified minimum database resource allocation amount, wherein:
the user-specified minimum database resource allocation amount specifies a minimum quantity of the database resource that the database job must be allocated to be the primary database resource consumer for the database resource; and
determining whether the database job is the primary database resource consumer for the database resource is further based on the user-specified minimum database resource allocation amount.

12. The computer-readable storage medium of claim 9, wherein the list further comprises:
a database resource allocation limit for the database resource;
the database resource allocation amount;
a timestamp specifying the time when the database job was allocated the database resource allocation amount; and
the database resource.

13. The computer-readable storage medium of claim 12, wherein the database resource is at least one of:
SQL open cursors;
large object locators;
call level interface handles; and
SQL active descriptors.

14. The computer-readable storage medium of claim 9, further comprising:
receiving a plurality of requests for the plurality of database resources from a plurality of database jobs;
based on the plurality of requests, updating a plurality of database resource allocation amounts of the plurality of database resources for the respective database jobs, wherein the plurality of database resource allocation amounts specify a respective amounts of the plurality of database resources allocated to the respective database jobs; and
determining a plurality of primary consumers for each of the plurality of database resources, wherein the plurality of primary consumers is the plurality of database resource consumers allocated an amount of each of the plurality of database resources in excess of a certain amount relative to other database resource consumers, the determining based on the plurality of database resource allocation amounts of the plurality of database resources, allocated to the plurality of database jobs.

15. The computer-readable storage medium of claim 14, further comprising:
receiving a request to view the plurality of primary database resource consumers for the plurality of database resources; and
outputting the list for display.

16. The computer-readable storage medium of claim 14, further comprising:
receiving a plurality of user-specified minimum database resource allocation amounts; and
determining the plurality of primary database resource consumers for each of the plurality of database resources is further based on the plurality of user-specified minimum database resource allocation amounts.

17. A system, comprising:
a memory containing code;
a processor which, when executing the code:
receives, from a database job, a request for a database resource of a plurality of database resources;
based on the request, updates a database resource allocation amount of the database resource for the database job, wherein the database resource allocation amount specifies an amount of the database resource allocated to the database job; and
determines whether the database job is a primary consumer for the database resource, wherein a primary consumer is defined according to a consumption of the database resource relative to other database resource consumers, the determining based on:
the database resource allocation amount of the database resource, allocated to the database job; and
a respective database resource allocation amount of the database resource, allocated to each of the plurality of database resource consumers;
upon determining that the database job is one of the plurality of primary consumers for the database resource:
adds the database job to a list identifying one or more primary database resource consumers for the database resource; the list being stored on a computer readable storage medium.

18. The system of claim 17, wherein the processor further:
receives a user request to view the one or more primary database resource consumers for the database resources; and
presents the list to the user.

19. The system of claim 17, wherein the processor further:
receives a user-specified minimum database resource allocation amount, wherein:
the user-specified minimum database resource allocation amount specifies a minimum quantity of the database resource that the database job must be allocated to be the primary database resource consumer for the database resource; and
determines whether the database job is the primary database resource consumer for the database resource is further based on the user-specified minimum database resource allocation amount.

20. The system of claim 17, wherein the list further comprises:
a database resource allocation limit for the database resource;
the database resource allocation amount;
a timestamp specifying the time when the database job was allocated the database resource allocation amount; and
the database resource.

21. The system of claim 20, wherein the database resource is at least one of:
SQL open cursors;
large object locators;
call level interface handles; and
SQL active descriptors.

22. The system of claim 17, wherein the processor further:
receives a plurality of requests for the plurality of database resources from a plurality of database jobs;
based on the plurality of requests, updates a plurality of database resource allocation amounts of the plurality of database resources for the respective database jobs, wherein the plurality of database resource allocation amounts specify a respective amounts of the plurality of database resources allocated to the respective database jobs; and
determines a plurality of primary consumers for each of the plurality of database resources, wherein the plurality of primary consumers is the plurality of database resource consumers allocated an amount of each of the plurality of database resources in excess of a certain amount relative to other database resource consumers, the determining based on the plurality of database resource allocation amounts of the plurality of database resources, allocated to the plurality of database jobs.

23. The system of claim 22, wherein the processor further:
receives a request to view the plurality of primary database resource consumers for the plurality of database resources; and
outputs the list for display.

24. The system of claim 22, wherein the processor further:
receives a plurality of user-specified minimum database resource allocation amounts; and
determines the plurality of primary database resource consumers for each of the plurality of database resources is further based on the plurality of user-specified minimum database resource allocation amounts.
